(19) United States
(12) Patent Application Publication
(10) Pub. No.: US 2009/0292739 A1
(43) Pub. Date: Nov. 26, 2009

(54) Methods and Systems for Service Tracking and Timeline Updating

(75) Inventors: Lawrence J. Marsh, Scottsdale, AZ (US); John M. Wepler, Hudson, OH (US); Patrick T. Linnert, Concord, OH (US); Andrew C. Roberts, Perry, OH (US); Michael E. Branstein, Prospect, KY (US)

Correspondence Address: EDWARDS ANGELL PALMER & DODGE LLP, P.O. BOX 55874, BOSTON, MA, 02205, US

(73) Assignee: Marsh, Berry & Company, Inc.

(21) Appl. No.: 12/471,324

(22) Filed: May 22, 2009

Related U.S. Application Data
(60) Provisional application No. 61/055,377, filed on May 22, 2008.

(51) Int. Cl. G06F 17/30; G06F 3/048

(52) U.S. Cl. 707/200; 715/764; 707/E17.005

(57) ABSTRACT

A system for tracking and managing value-added services and service timelines provided to a client by an agency. The system includes a secure web-based interface and a database, the database being connected to the web-based interface and including client account data. The system also includes an agency set-up portion of the web-based interface allowing an authorized administrator to associate the client account data with an agency account, a service timeline portion of the web-based interface allowing an authorized user to view and edit an interactive client account service timeline generated from the client account data. The interactive client account service timeline includes a plurality of editable data fields, including editable data fields for a value-added service category, a description of a value-added service, a tracking metric, a list of one or more participants, a target date for completion of the service, and an actual completion date for the service.

### CROSS REFERENCE TO RELATED APPLICATION

This application claims priority to U.S. Provisional Patent Application No. 61/055,377, filed May 22, 2008, the entire disclosure of which is herein incorporated by reference. This application is related to an application titled “Systems and Methods for Sales Tracking, Accountability, and Reporting”, which is jointly owned and was filed in the U.S. Patent and Trademark Office concurrently with the present application. The entire disclosure of the above mentioned application is also incorporated herein by reference.

### COPYRIGHT NOTICE

Portions of the disclosure of this patent document, including the drawings, contain material which is subject to copyright protection. The copyright owner has no objection to the reproduction of the patent document or the patent disclosure, as it appears in the records and files of the U.S. Patent and Trademark Office, but otherwise reserves all copyrights whatsoever.

### BACKGROUND OF THE INVENTION

1. Field of the Invention

The present invention relates to a system for tracking sales promises and results. More particularly, the present invention is directed to a web-based sales tracking, accountability, and results technology platform that is particularly well-suited for insurance professionals.

2. Description of Related Art

Delivering on commitments made to clients is a key factor in the success of any business. This is especially true for professionals whose primary business is based on delivering services to clients rather than tangible goods. Insurance agents and brokers are an example of such service oriented professionals.

The profitability of an insurance agency is based in large part on the agency's ability to differentiate itself from competing agencies by offering value-added services. Long-term agent/broker relationships with its customers (insureds) are often terminated based on issues relating to service, not just price. Consequently, it is critical that an insurance agency provides value-added services that enable the agency to enhance retention of existing clients while maximizing new business production. While value-added services are not new to insurance distributors, very few agents and brokers have fully developed and executable programs supported by an adequate technology infrastructure.

Public brokers have been utilizing value-added service programs for several years. Most public brokers have well-defined internal capabilities listings, are experts at selling the value of their services, and maintain well-documented roles and responsibilities within their organizations. However, most public brokers still fall short when it comes to consistent delivery and communication of the their value-added services. Generally, the brokers are making promises to insureds without ensuring that those promises are kept. Large, privately held regional insurance agencies suffer from similar problems, and though such agencies have worked to develop value-added services programs, they have failed to create systems with sufficient compliance auditing and service timeline features.

Bank-owned insurance agencies have also spent time and resources developing value-added service programs, but generally have been slow and reactive. These organizations have viewed value-added service programs as a necessity to compete with public brokers and large regional agents/brokers for new and retained business. Bank-owned agencies have also failed to create a complete program that includes a compliance auditing process.

For most small and medium sized insurance agencies, the concept of selling value-added services, let alone tracking compliance regarding such services, has not formed a central part of their business. Many agencies in this category have just recently realized that their larger competitors are focused on this activities and that ignoring such value-added services will be detrimental to the health of their agencies. Overall, agents and brokers are now using value-added services to target larger and smaller accounts than they previously would have targeted. They are also seeking to foster growth and profitability in part by expanding their pool of potential customers.

There is a compelling need for an integrated, robust technology platform for creating, tracking, managing, and auditing service timelines that can be used by professional service agencies of any size to better implement value-added service programs. Accordingly, the present invention is directed to a system and methods of service tracking and timeline updating that meets these needs.

### SUMMARY OF THE INVENTION

Advantages of the present invention will be set forth in and become apparent from the description that follows. Additional advantages of the invention will be realized and attained by the methods and systems particularly pointed out in the written description and claims, as well as from the appended drawings.

To achieve these and other advantages and in accordance with the purpose of the invention, as embodied herein, the invention includes a system for tracking and managing value-added services and service timelines provided to a client by an agency. The system includes a secure web-based interface and a database, the database being connected to the web-based interface and including client account data. The system also includes an agency set-up portion of the web-based interface allowing an authorized administrator to associate the client account data with an agency account, a service timeline portion of the web-based interface allowing an authorized user to view and edit an interactive client account service timeline generated from the client account data. The interactive client account service timeline includes a plurality of editable data fields, including editable data fields for a value-added service category, a description of a value-added service, a tracking metric, a list of one or more participants, a target date for completion of the service, and an actual completion date for the service.

A method for tracking and managing value-added services provided to a client by an agency is also provided. The method includes the steps of 1) creating a client account within a secure web-based interface; 2) populating a database with data regarding the client account using the web-based interface; 3) automatically generating an interactive service timeline for the client account using the data stored in the database; 4) outputting the interactive service timeline to the web-based interface; and 5) allowing an authorized user to view and modify the interactive service timeline. The service timeline includes data fields for a service activity, the service activity being associated with at least one of a target completion date, a participant, a tracking metric, and an actual completion date.

It is to be understood that the foregoing general description and the following detailed description are exemplary and are intended to provide further explanation of the invention claimed. The accompanying drawings, which are incorporated in and constitute part of this specification, are included to illustrate and provide a further understanding of the method and system of the invention. Together with the description, the drawings serve to explain principles of the invention.

### BRIEF DESCRIPTION OF THE DRAWINGS

FIG. 1 is a schematic view of the system for tracking and managing value-added services and service timelines of the present invention.

FIG. 2 illustrates a portion of a Home page of the user interface that forms a part of the system of the present invention.

FIG. 3 illustrates a Service Timeline Setup page of the user interface that forms a part of the system of the present invention.

FIG. 4 illustrates a Tracking Metrics page of the user interface that forms a part of the system of the present invention.

FIG. 5 illustrates a Service Categories page of the user interface that forms a part of the system of the present invention.

FIG. 6 illustrates a Client Services page of the user interface that forms a part of the system of the present invention.

FIG. 7 illustrates a Category Mappings page of the user interface that forms a part of the system of the present invention.

FIG. 8 illustrates a Metric Bands page of the user interface that forms a part of the system of the present invention.

FIG. 9 illustrates a Report Templates page of the user interface that forms a part of the system of the present invention.

FIG. 10 illustrates a Service Timeline menu that forms part of the Home page illustrated in FIG. 1.

FIG. 11 illustrates a Service Timelines page of the user interface that forms a part of the system of the present invention.

FIG. 12 illustrates a Manage Timeline page of the user interface that forms a part of the system of the present invention.

FIG. 13 illustrates a floating menu accessed from the Manage Timeline page of FIG. 12.

FIG. 14 illustrates an Add Activity window accessible through the Manage Timeline page shown in FIG. 12.

FIG. 15 illustrates a Timeline Reports page of the user interface that forms a part of the system of the present invention.

FIG. 16. illustrates a Compliance Report page of the user interface that forms a part of the system of the present invention.

FIG. 17 illustrates a portion of a Compliance Report page of the system of the present invention.

FIG. 18 illustrates a Service Level report page of the system of the present invention.

### DETAILED DESCRIPTION OF PREFERRED EMBODIMENTS

Reference will now be made in detail to the present preferred embodiments of the service tracking and timeline updating system and methods, examples of which are illustrated in the accompanying drawings.

The present invention includes a technology platform that allows insurance professionals such as agents and brokers to become more efficient and effective in creating, managing, and auditing service commitment timeliness Although this specification makes reference to insurance agents/brokers and insurance agencies, it should be understood that the systems and methods of the present invention are also applicable to a wide variety of other businesses and organizations.

The system provides insurance agents and brokers with a common organizational platform for all agency personnel to review client activities and progress. The system also allows an agency to institutionalize the consistency of service timelines across various agent/broker departments and personnel, and to measure services provided to insureds relative to agent/broker delivery time and costs, so as to ensure a proper blend of service relative to price. The system is able to maintain an historical data repository of services provided to each insured. The system also allows for compliance auditing to assess service commitments promised, the status of each promise, and execution outcome. Compliance reports can be accessed by all agency personnel associated with a given client account, from individual agents, to an account manager, to an executive officer of the agency. The system allows users to proactively leverage service timelines to provide a higher level of value-added services to customers.

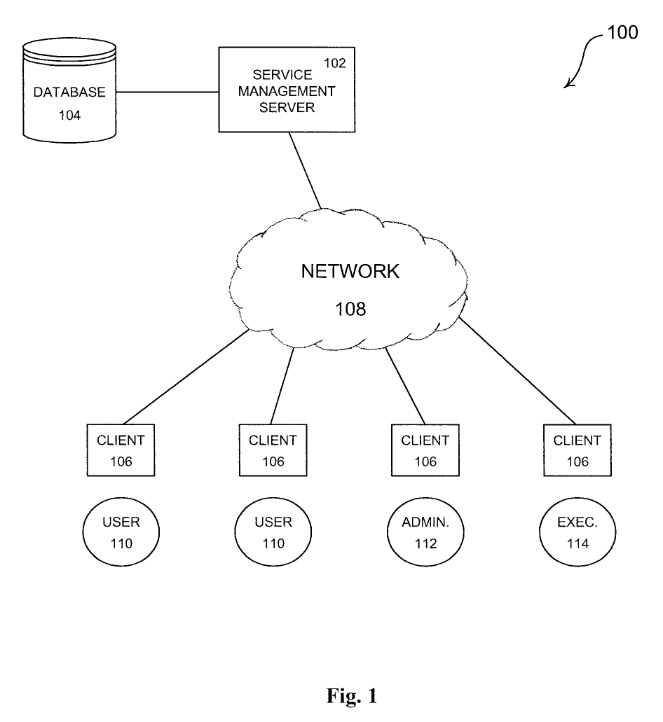

For purposes of explanation and illustration, and not limitation, an exemplary embodiment of a system in accordance with the present invention is shown in FIG. 1 and designated generally by the reference numeral 100. System 100 includes a service management server computer 102, a database 104, and a plurality of client devices 106. Database 104, service management server 102, and client devices 106 may interface with one another via a network 108. Network 108 may be any suitable network, including a company intranet or other local area network, a wide area network, and the Internet. Server 102 may include a plurality of servers, and database 104 may include a plurality of databases. Client devices may include a computer, a mobile phone, or any other network-enabled device.

System 100 may comprise software components running on either service management server 102 or clients 106. Server 102 and clients 106 may run any suitable operating system and may include a variety of hardware configurations. Both service management server 102 and clients 106 may include a processor coupled to a memory module and to a mass storage device via a bus or other communication medium; a display or other output device interfacing with the processor; and a keyboard, mouse, touchpad, or other input device that receives input from a user and interfaces with the processor. In one exemplary embodiment, clients 106 each include an input device for receiving user input and a display device for displaying content. The software implementing system 100 may include instructions written in a high level computer language and stored in a mass storage device. In one exemplary embodiment, a plurality of modules having distinct functions run on service management server 102.

System 100 is preferably a permission-based system. That is, access to different parts of the system is based on the permission level granted to each individual user. For example, system 100 may grant certain access permissions to a user 110, who may be an agent or broker. User 110 may have the ability to create, update, and modify timelines, for example, but will not have permission to create service categories, services, and service timeline templates. User 110 may be granted access to only those timelines that fall under the responsibility of the user, or the user may be granted permission to access all agency timeliness System 100 may grant additional access permissions to an administrator 112. Administrator 112 may have permission to add, modify, and delete service categories, service descriptions, and timeliness Administrator 112 may also be able to perform a variety of administrative functions that will not be available to user 110. System 100 may also grant a different set of permissions to an executive user 114. Executive user 114 may have permission to view data and reports relating to the entire agency, but may not have permission to perform administrative tasks within system 100.

In one exemplary embodiment, service management server 102 requires authentication from user 110 prior to allowing access to software application 106. Upon receiving a request from a web browser, central server 102 may require user 110 to enter a user name and password. However, the step of authentication could also be accomplished by other suitable means. Once service management server 102 has determined that user 110 is an authorized user, user 110 will be granted access to web-based software application 106. In one exemplary embodiment, user 110 is an individual insurance agent or broker. Administrator 112 and executive user 114 are authenticated and granted access to system 100 in a similar manner.

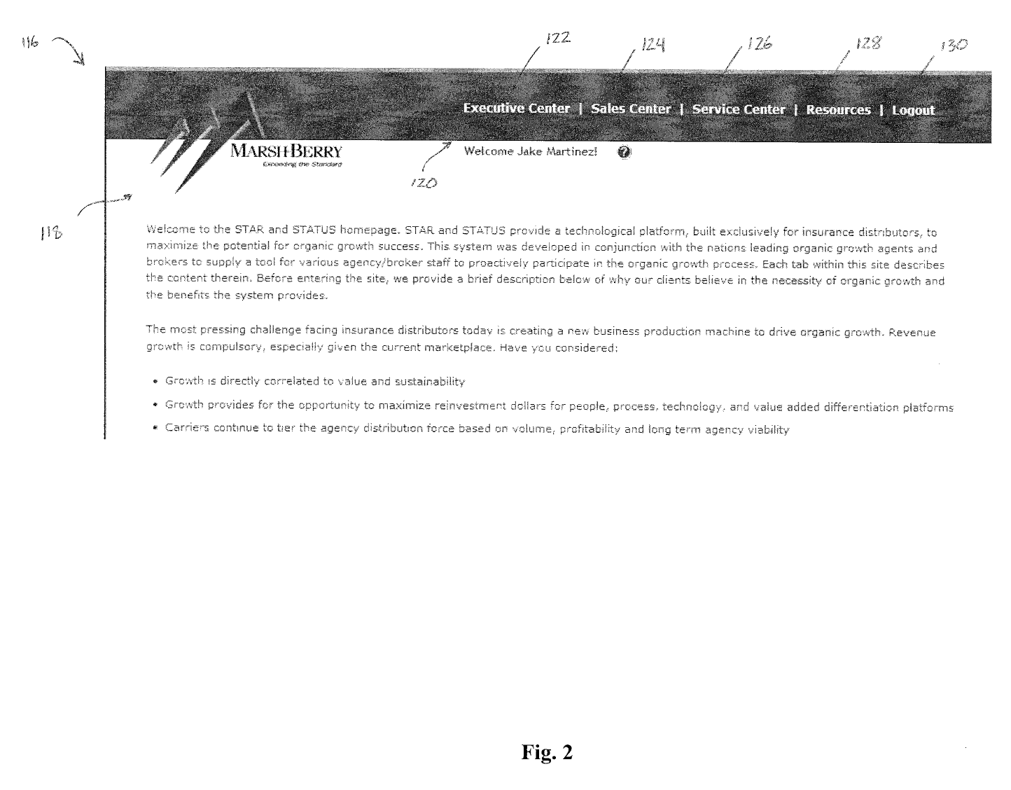

FIG. 2 illustrates a portion of a graphical user interface 116 of an exemplary embodiment of system 100. Once service management server 102 has authenticated user 110, user 110 will be have access to a homepage 118, as shown in FIG. 2. Homepage 118 includes a plurality of links or buttons 120 that may be selected by the user. In the exemplary embodiment shown in FIG. 2, links 120 include an Executive Center link 122, a Sales Center link 124, a Service Center link 126, a Resources link 128, and a Logout link 130. In one exemplary embodiment, links 120 are available in the same location on each page that is presented to user 110, thus facilitating navigation of user interface 116.

Interface 116 includes an agency set-up portion and a service timeline portion. In one exemplary embodiment, the agency set-up portion is accessible only to users having administrative privileges on system 100, such as administrator 112. The agency set-up portion is accessed by clicking or otherwise selecting Resources link 128, which will call up a menu including an Agency Setup link 132. In one exemplary embodiment, Agency Setup menu will allow administrator 112 to access a User Setup page. User Setup page will allow administrator 112 to add, delete, or modify information about authorized users 110 and executive users 114. In one exemplary embodiment, User Setup page includes functionality for uploading pictures of users and creating a user biography within a user's profile.

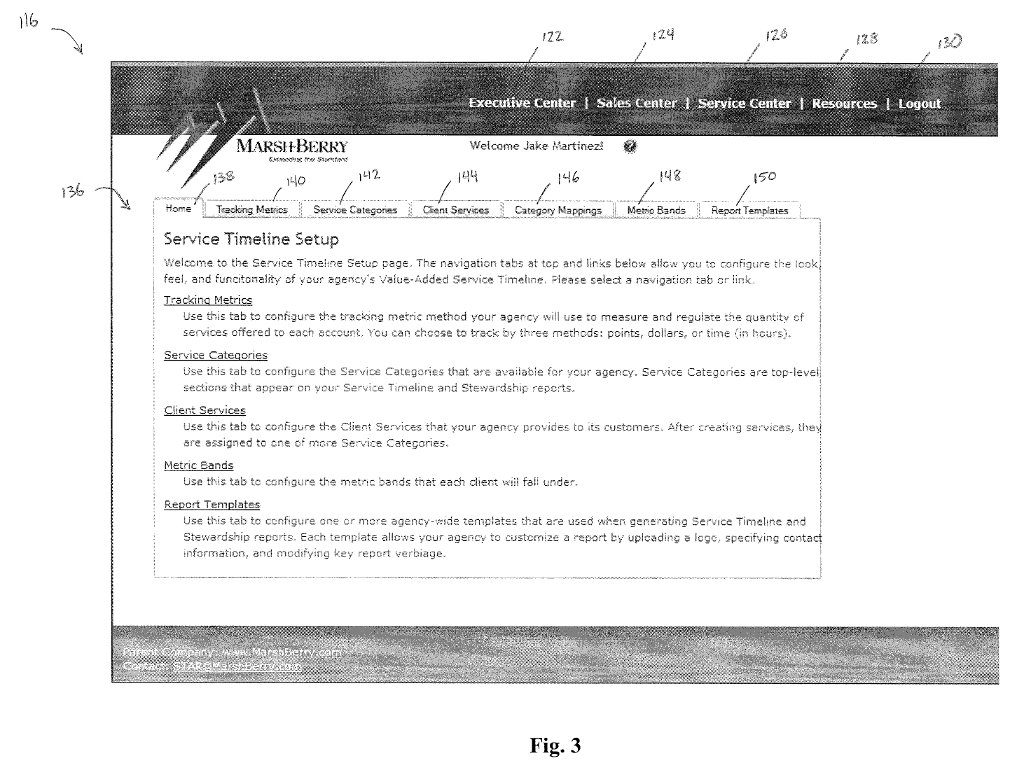

Agency Setup menu may also allow administrator 112 to access a Service Timeline Setup page 136, as shown in FIG. 3. Service Timeline Setup page 136 includes a plurality of navigation tabs that allow user 110 to configure the look, feel, and functionality of service timeliness The navigation tabs include a Home tab 138, a Tracking Metrics tab 140, a Service Categories tab 142, a Client Services tab 144, a Category Mappings tab 146, a Metric Bands tab 148, and a Report Templates tab 150.

Home tab 138 provides an overview of the service timeline setup process, with a link to each one of the tabs and a brief explanation of the portion of the set up process that relates to each tab.

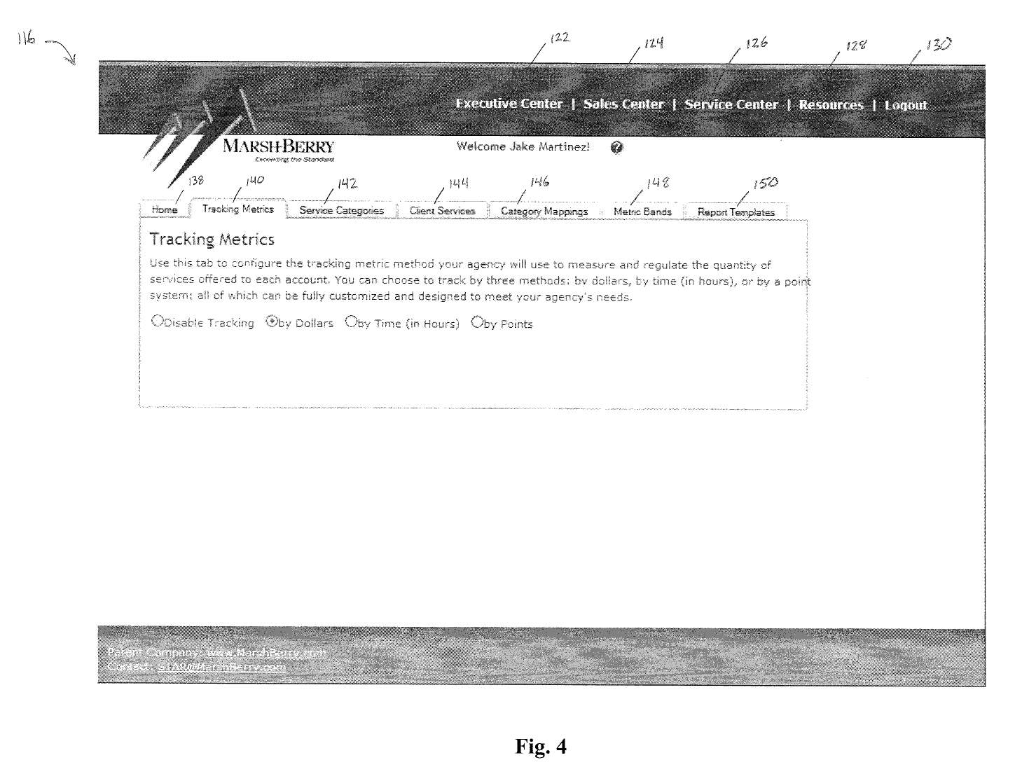

As shown in FIG. 4, Tracking Metrics tab 140 allows administrator 112 to configure the tracking metric method the agency will use to measure and regulate the quantity of services offered to each account. User 110 will be able to select from a variety of tracking metrics, including dollars, hours, and points. The tracking metric used can be customized and designed to meet the agency's needs.

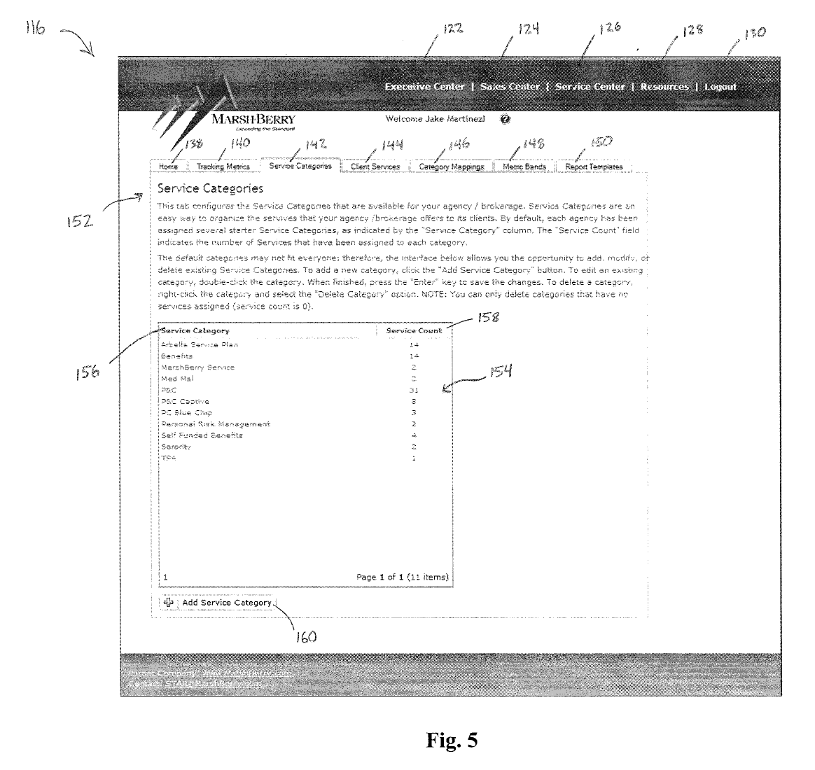

FIG. 5 illustrates a Service Categories page 152 accessed by Service Categories tab 142. Service Categories page 152 allows administrator 112 to configure the service categories that will be available to brokers/agents using the system. Service categories are top-level sections that appear in service timeliness Service categories function to organize the services that an agency offers to its clients. By default, each agency will be assigned four top-level service categories: General, Commercial, Personal, and Group Benefits. However, system 100 allows administrator 112 to add, modify, or delete service categories depending on the needs of the agency. Service Categories page 152 may include an editable table 154 having a Service Category heading 156, below which is listed the various top-level service categories, and a Service Count heading 158, below which are listed the number of services that currently exist within each of the Service Categories. Service Categories page 152 may also include an Add Service Category button 160, to allow administrator 112 to easily add or delete service categories.

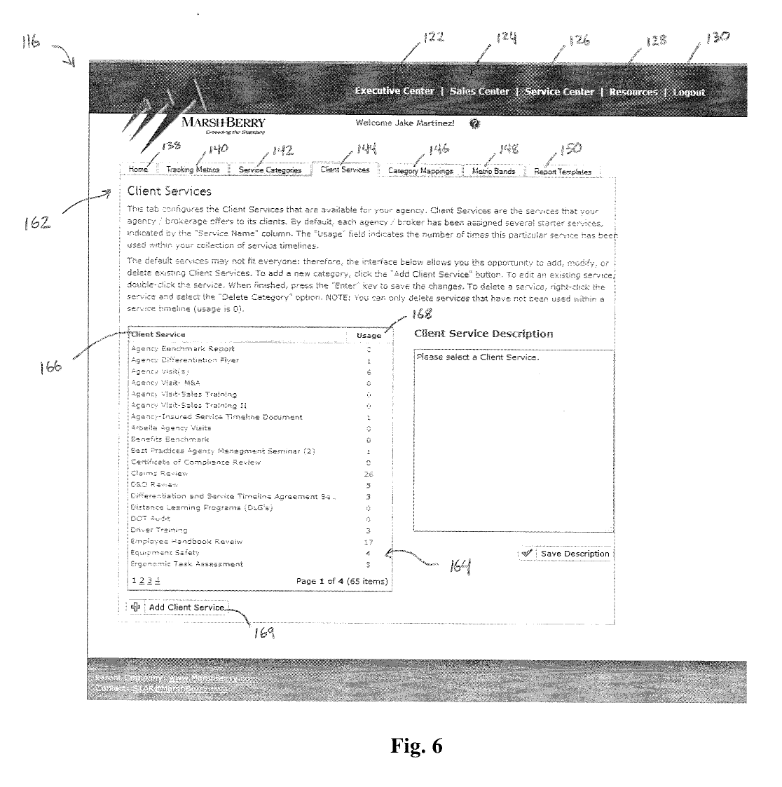

FIG. 6 illustrates a Client Services page 162, accessed through Client Services tab 144. Client Services page 162 allows administrator 112 to configure the client services that are available under each of the top-level service categories. Client Services page 162 may include an editable table 164 with a list of client services under a Client Services heading 166. Editable table 164 may also include a Usage heading 168 that lists the number of instances that each of the client services is currently being utilized in existing agency service timeliness Examples of client services that may be listed under the Client Services heading 166 include a business review of a past policy, a contract review, a coverage review, a facilities assessment, and an on-site visit. The Client Services available under each of the top-level Service Categories are not predetermined, allowing administrator 112 to define which services will be included. An Add Client Service button 169 may be included on Client Services page to allow administrator 112 to add or remove client services from editable table 164.

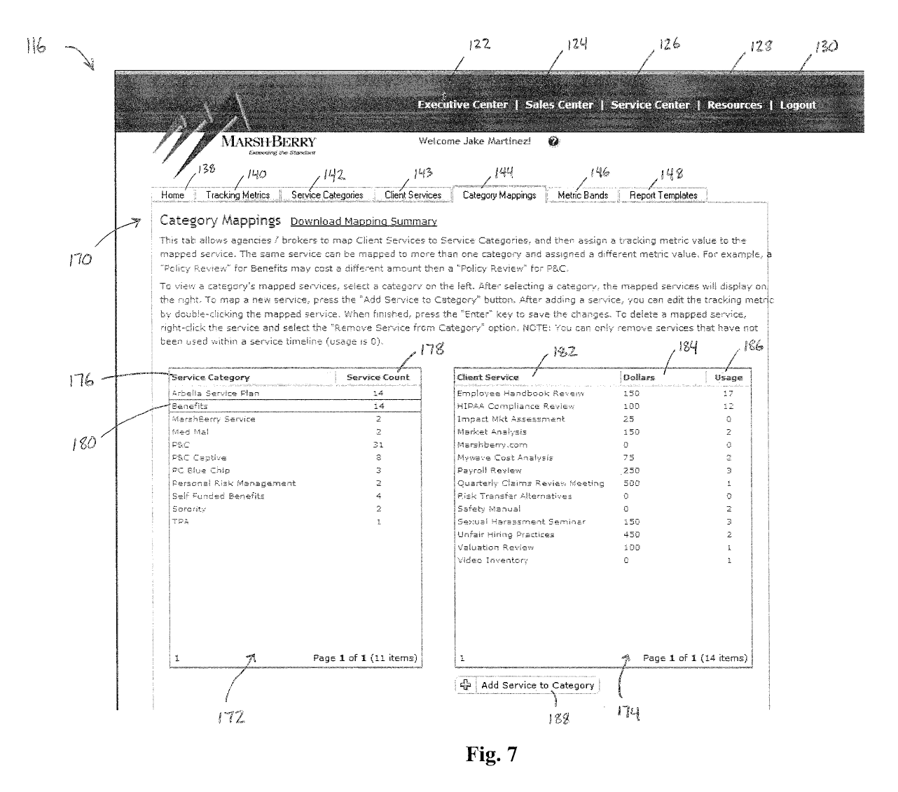

FIG. 7 illustrates a Category Mappings page accessed through Category Mappings tab 146. Category Mappings page 170 allows administrator 112 to map client services to top-level service categories and to assign metric values to client services. In the exemplary embodiment shown in FIG. 7, Category Mappings page 170 includes a first table 172 and a second table 174. First table 172 includes a Service Category heading 176 and a Service Count heading 178. The various service categories, either preexisting or created by administrator 112 in Service Categories page 152, are listed in first table 172 under Service Category heading 176. Service Count heading 178 indicates how many client services are mapped to each of the top-level service categories. For example, as shown in FIG. 7, Benefits 180 is a top-level service category with fourteen client services mapped to the Benefits category 180. The category mappings are included in second table 174, which includes a Client Services heading 182, a Tracking Metric heading 184, and a Usage heading 186. When a top-level service category is selected in first table 172, second table 174 will show each of the client services that are currently mapped to the selected top-level service category. For example, when administrator 112 selects Benefits 180 in first table 172, second table 174 displays fourteen client services, including Employee Handbook Review, HIPAA Compliance Review, Payroll Review, Market Analysis, and Quarterly Claims Review Meeting, among others. Each of these fourteen client services are listed under Client Services heading 182.

Each of the client services is also assigned a tracking metric value, which is displayed in second table 174 below the Tracking Metric heading 184. As indicated above, the tracking metric could be dollars, time (in hours), points, or another metric defined by administrator 112. Each client service is assigned a certain tracking metric value. For example, as shown in FIG. 7, the Employee Handbook Review service may be assigned tracking metric value of 150, while the Quarterly Claims Review Meeting service may be assigned a tracking metric value of 500.

Category Mappings page 170 also includes an Add Service to Category button 188. By clicking on or otherwise selecting button 188, administrator 112 is able to add an existing client service, as listed on Client Services page 162, to the currently selected service category. In other words, administrator 112 is able to map additional client services to the existing service categories shown in first table 172. The selected top-level service categories and client services can then be made available to users 110 in creating service timelines.

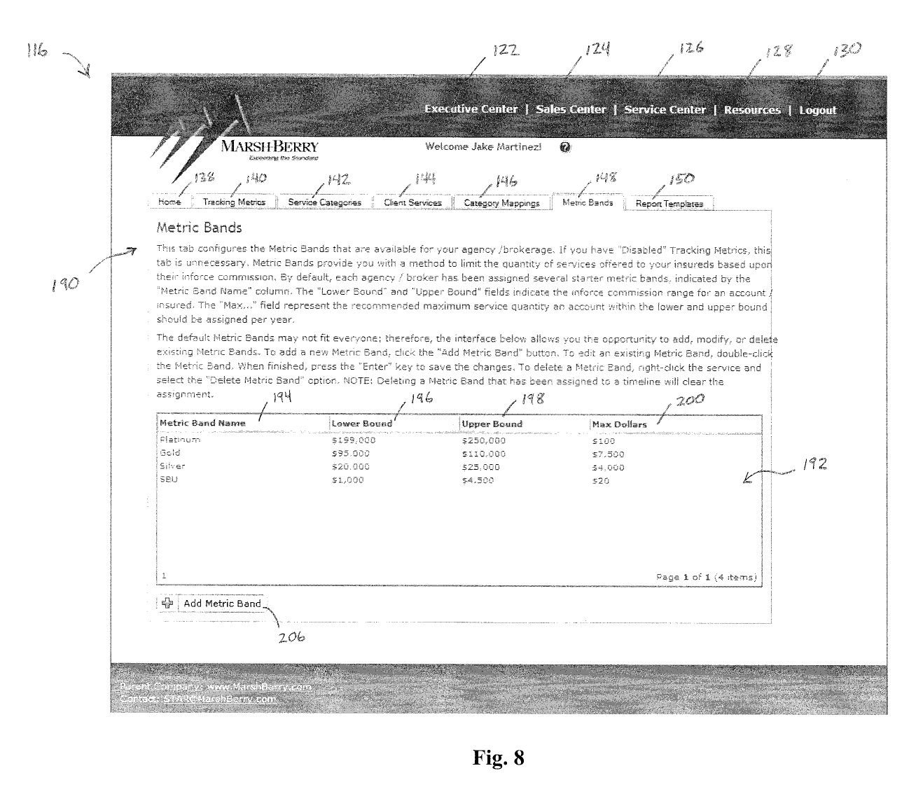

FIG. 8 illustrates a Metric Bands page 190, accessed through Metric Bands tab 148. Metric Bands page 190 allows administrator 112 to configure metric bands that will determine the amount of value-added service, as measured by the tracking metric, that will be provided to each client account. In the exemplary embodiment, the metric bands are completely customizable based on the agency's needs and can be added to, deleted, or modified by administrator 112. In the exemplary embodiment shown in FIG. 8, Metric Band page 190 includes a Metric Band table 192 having a Name heading 194, a Lower Bound heading 196, an Upper Bound heading 198, a Max Dollars heading 200, and an optional Service Category heading (not shown). In the exemplary embodiment shown in FIG. 8, four metric bands are listed below Name heading 194: Platinum, Gold, Silver, and SBU. Each metric band encompasses an upper bound and a lower bound, representing the value of the account, as measured in dollars of potential commission. Interface 116 allows administrator 112 to assign a maximum amount of value-added services to be provided to a client falling within the metric band, as measured by the selected tracking metric. For example, according to the Metric Band table 192 shown in FIG. 8, if a client account generates over $95,000 in commission, the account would be classified as a Gold account and would be entitled to $7,500 worth of value-added services. Metric Band table 192 can be customized by administrator 112. In one exemplary embodiment, Metric Band table 192 includes a Modify link for each of the existing metric bands in Metric Band table 192, allowing administrator 112 to quickly change the name, upper bound, lower bound, and the maximum amount of value-added services permitted for each of the metric bands. Metric Band page 190 may also include an Add Metric Band button or link 206, which allows administrator 112 to further customize Metric Band table 192 by adding or deleting a metric band along with the information associated with the metric band.

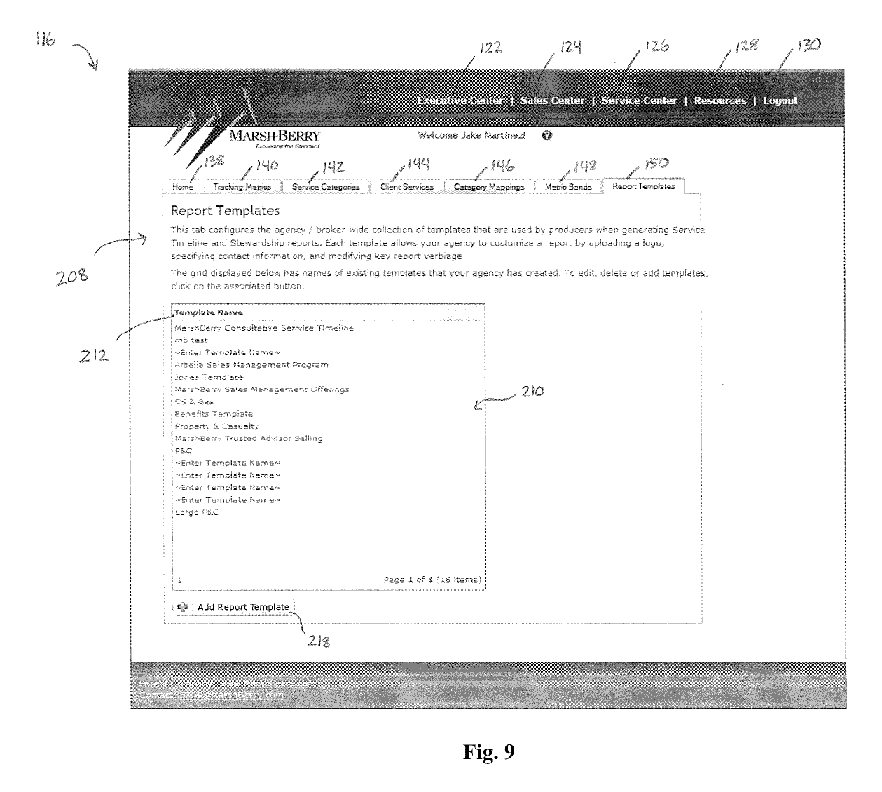

As shown in FIG. 9, Report Templates tab 150 provides access to a Report Templates page 208. Report Templates page 208 allows administrator 112 to configure one or more agency-wide templates that are used when generating service timeline reports and stewardship reports. Each template allows the agency to customize a report by uploading a logo, specifying contract language, and modifying key language that is to be included in the report.

Report Templates page 208 displays a table 210 that includes a Template Name heading 212. Table 210 may also include functionality for modifying or deleting a template once it has been created. An Add Report Template button 218 may also be incorporated into Report Templates page 208. Selecting Add Report Template button 218 will take administrator 112 to a report template wizard, which will assist administrator 112 in designing suitable service timeline and stewardship report templates for the agency. In one exemplary embodiment, the report template wizard will take administrator 112 through a series of steps for setting up a report template. Administrator 112 will be able to customize the template to include the name of the report, the name and address of the agency/brokerage, a custom image, a logo, and form paragraphs or other contract language to be included in the timeline report template. Administrator 112 will also be able to add text that includes a service commitment contract that may be included as part of the report.

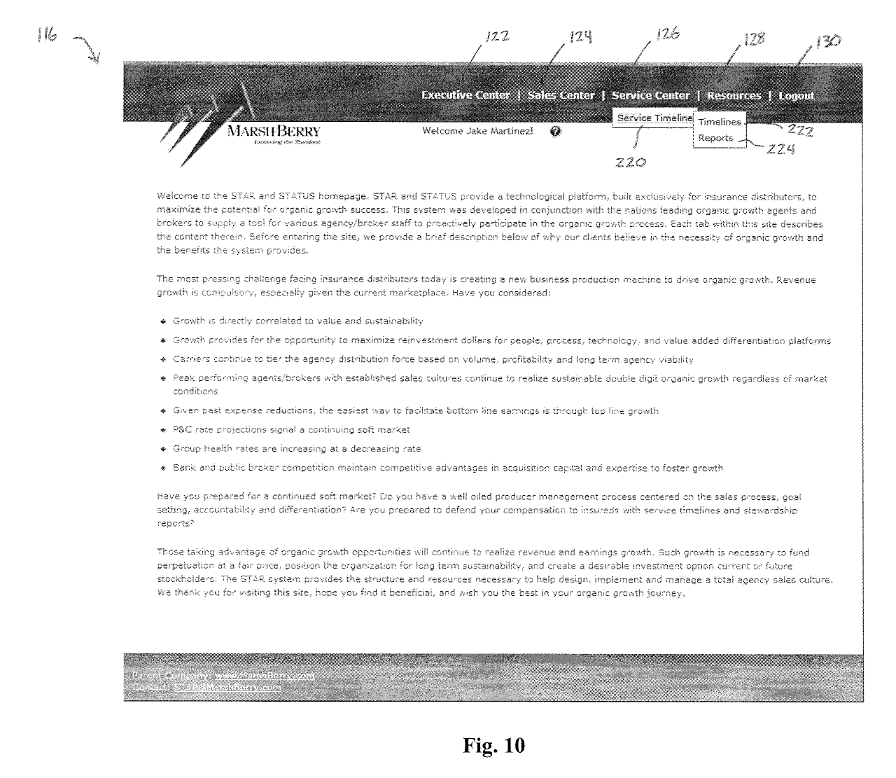

FIG. 10 illustrates a menu for accessing the service timeline portion of interface 116. The service timeline portion is preferably accessible to general broker/agent users 110. As shown in FIG. 10, user 110 may access a Service Timeline menu 220 by selecting Service Center link 126, either from homepage 118, or from any other page of user interface 116. The Service Timeline menu 220 includes at least two options: a Timelines option 222 and a Reports option 224.

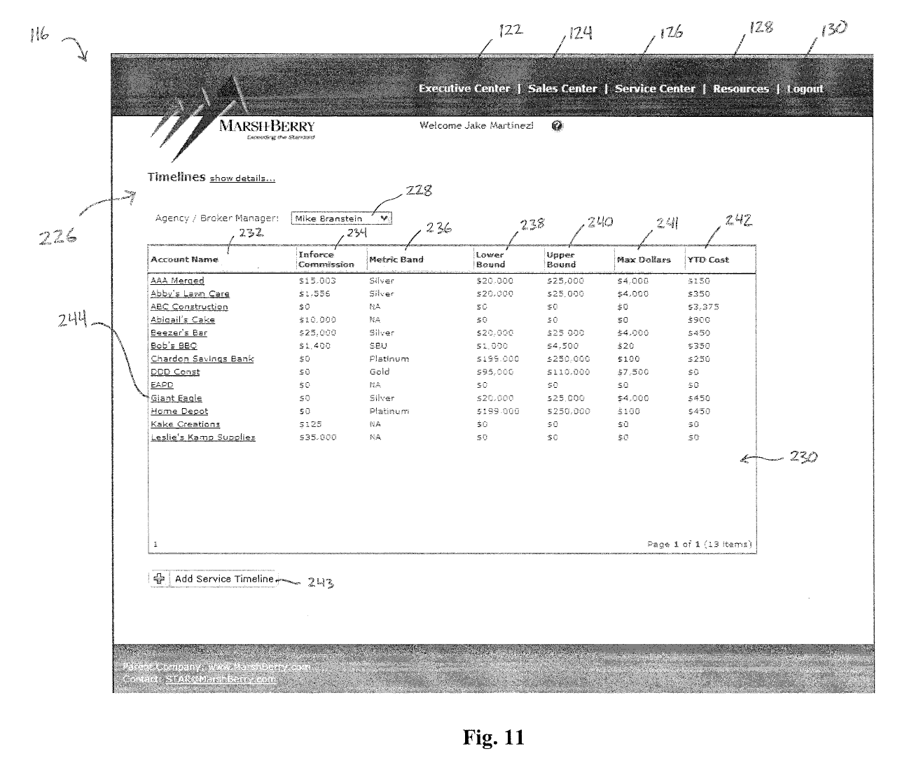

FIG. 11 illustrates a Service Timelines page 226, accessed by selecting Timelines option 222. Service Timelines page 226 displays all service timelines associated with a selected agency/broker manager. An agency/broker manager selection tool 228 may also be provided. Selection tool 228 will allow user 110 to view all service timelines assigned to a given manager. In one exemplary embodiment, user 110 may also have the option of viewing all timelines, that is, all service timelines for an organization or agency using selection tool 228.

My Service Timelines page 226 includes a table 230 listing the service timelines associated with an agency and/or user, with relevant information displayed about each service timeline. For example, as shown in FIG. 11, table 230 includes an Account Name heading 232, an Inforce Commission heading 234, and a Metric band heading 236, an Lower Bound heading 238, an Upper Bound heading 240, a Max Dollars heading 241, and a Year-to-Date (YTD) Cost heading 242. Service Timelines page 226 may also include functionality, for example through a floating menu within Service Timelines page 226, to deactivate and/or delete one or more of the timelines listed in table 230. Service Timelines page 226 may also include an Add Service Timeline button or link 243 allowing user 110 to add a service timeline, that is, to create a new service timeline for a new or an existing client.

In the embodiment shown, the name of the account, listed under Account Name heading 232, is a selectable link 244 that allows user 110 to access a Manage Timeline page 246 corresponding to the selected client account.

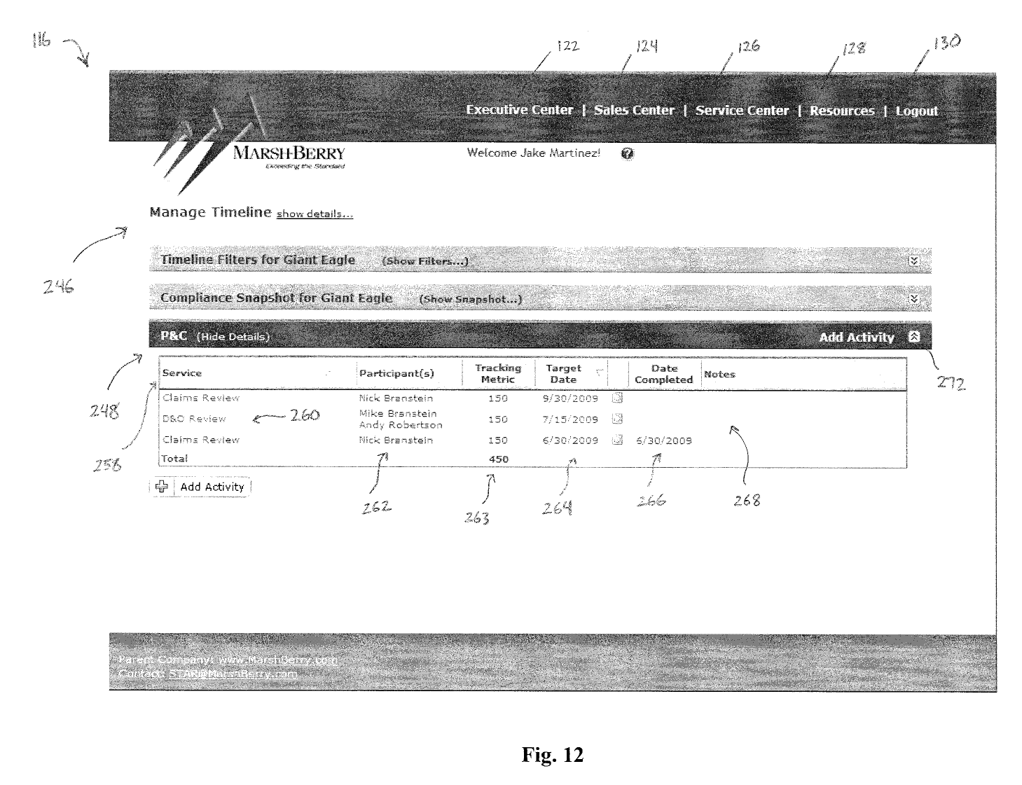

FIG. 12 illustrates an example of a Manage Timeline page 246 of interface 116, which is accessed by selecting one of the account name links 244. Manage Timeline page 246 includes a dynamic and interactive list of one or more service timelines associated with a given client. In on exemplary embodiment, Manage Timeline page 246 includes a plurality of service timelines, with each service timeline corresponding to different portions of the client's account. For example, as shown in FIG. 12, Manage Timeline page 246 may include a first timeline 248 for displaying a timeline of value-added services for Property and Casualty (P&C) related items. Additional timelines (not shown) for other value-added services may also be shown on the page. Manage Timeline page 246 may also include additional tools to allow user 110 to customize how each of the service timelines is viewed.

In the exemplary embodiment shown in FIG. 12, service timeline 248 is configured as a table, with a plurality of category headings 258 corresponding to one or more data fields. For example, as shown in FIG. 12, data fields may include Service data fields 260, Participant data fields 262, Tracking Metric data fields 263, Target Date data fields 264, Date Completed data fields 266, and Notes data fields 268. The service timelines shown in FIG. 12 can be edited and customized, depending on the access privileges granted to user 110. Information in Service data fields 260 is generally selected from a list of pre-determined and mapped value-added services as defined by administrator 112 in the service timeline setup portion of user interface 116. However, clicking on, or otherwise selecting individual Participant 262, Tracking Metric 263, Target Date 264, Date Completed 266, or Notes 268 data fields will allow user 110 to edit the field.

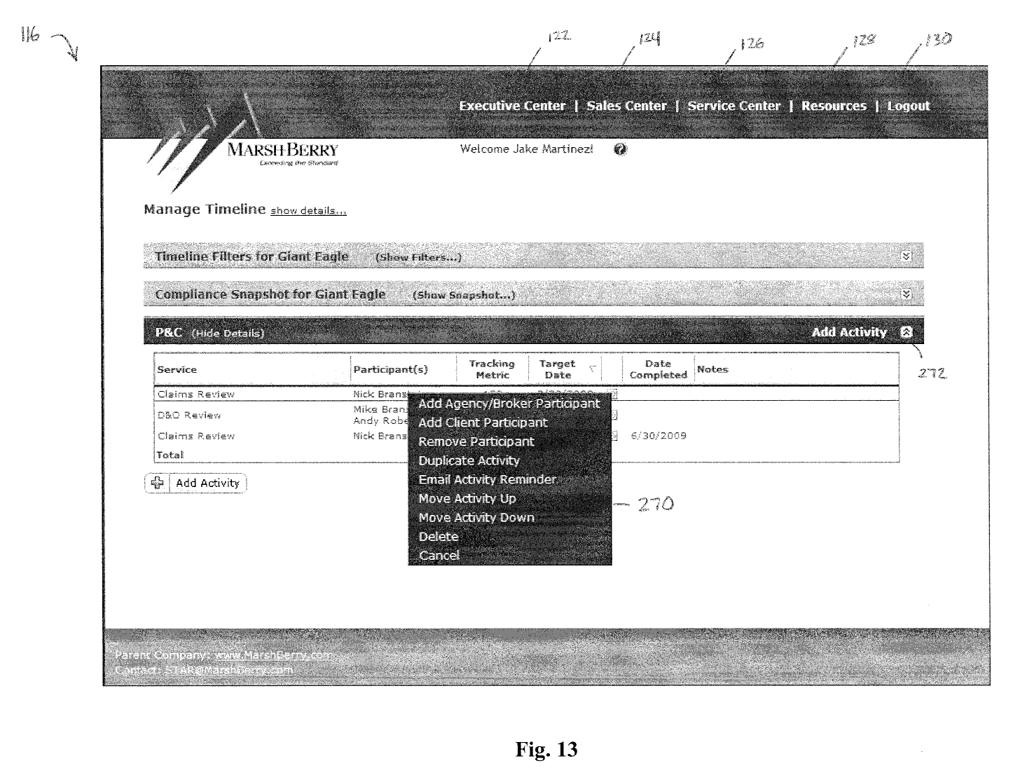

FIG. 13 illustrates a menu allowing a user to further edit the information in service timeline 248. In one exemplary embodiment, selecting Participant data field 262 within Manage Timeline page 246 will call up a floating menu window 270, as shown in FIG. 13, which allows user 110 to add an agency/broker participant, add a client participant, remove a participant, duplicate an activity, email an activity reminder, move an activity up or down on the list, or delete an activity from the timeline.

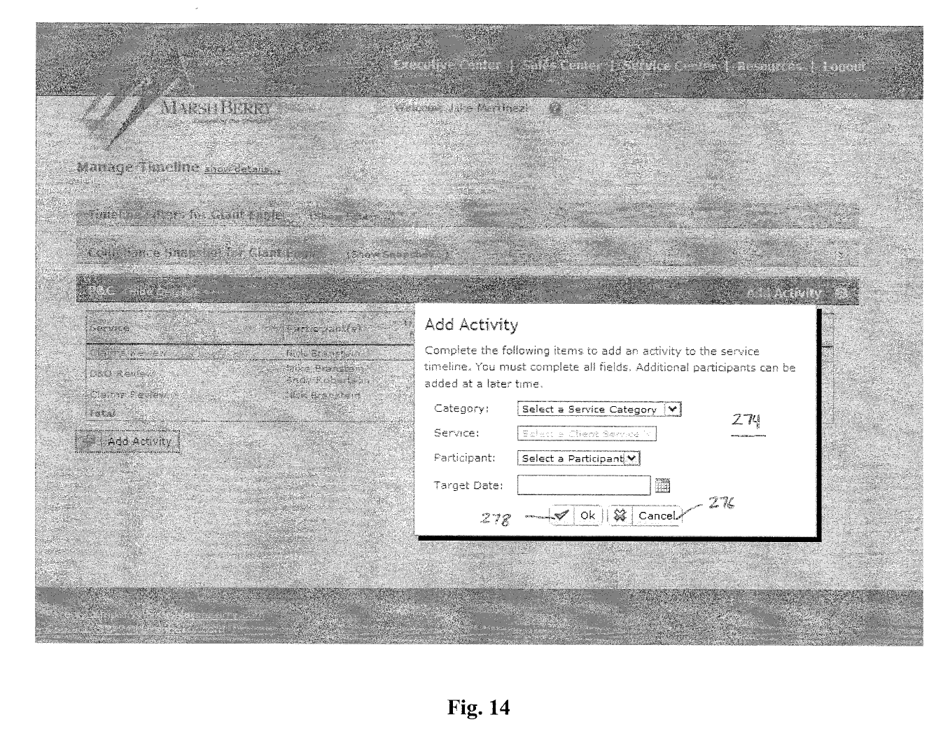

First timeline 148 and second timeline 150 may also include an Add Activity tool 272, as shown in FIGS. 12 and 13. Selecting Add Activity tool 272 calls up an Add Activity window 274, as shown in FIG. 14. Window 274 may include links, buttons, pull-down menus, data fields, or other suitable means for entering information that will populate the data fields of the service timelines shown on Manage Timeline page 246. Window 274 includes instructions for user 110 to follow to complete the necessary steps to add an activity to a selected service timeline. For example, user 110 may be select a top-level service category, a service activity mapped to the selected service category, and one or more participants for the service timeline. User 110 may also be required to enter a target date for the selected service activity. Once all required information has been entered into Add Activity window 274, user 110 may either choose to cancel the action by clicking on a Cancel button 276 or to add the activity by clicking an OK button 278.

Some of the data fields present in the service timelines displayed on Manage Timeline page 246 may be directly editable by user 110. For example, user 110 may be able to click on Target Date data field 264 to directly edit the target date. Similarly, the Date Completed field 266 and the Notes field 268 can be edited directly by clicking on or otherwise selecting the data field. Advantageously, these features allow user 110 to quickly and easily enter and update information relating to each activity found in the service timelines displayed on Manage Timeline page 246.

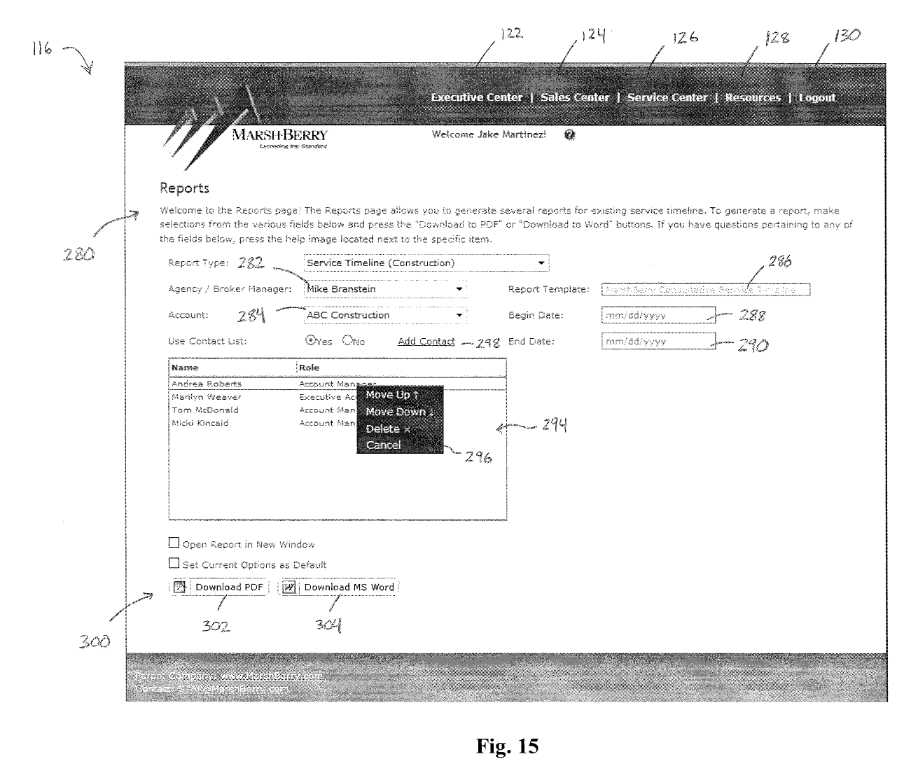

FIG. 15 illustrates a Timeline Reports page 280, which can be accessed by selecting the Reports option 224 from the Service Timeline Menu 220. Timeline Reports page 280 allows user 110 to generate a service timeline report and/or a stewardship report for any existing client. To generate a report, user 110 makes selections from a plurality of fields presented to the user on Timeline Reports page 280, including an Agency/Broker Manager field 282, an Account field 284, a Report Template field 286, a Begin Date field 288, an End Date field 290.

User 110 selects a manager from a pre-populated list of managers available in the Agency/Broker Manager field 282, and a report template from a pre-populated list of templates that have been created by administrator 112 and are listed in Report Template field 286. User 110 may also choose a client account as well as the desired beginning and ending dates that the report will cover, by selecting an existing client account from the Account field 284, and entering in the desired date ranges in the Begin Date field 288 and the End Date field 290. User 110 will also have the option of including a contact list in the report that is to be generated by using a Contact List tool 292. If administrator 112 chooses to include the contact list, user 110 will be able to select one or more individuals to be included in the contact list. The contact list may be shown in a table 294. By clicking on a name in table 294, user 110 will be able to access a menu 296 for editing the contact list. Menu 296 will allow user 110 to delete the name from the contact list, or move the name up or down in the contact list to change the order of names listed. An Add Contact link 298 may also be provided to allow a user with appropriate access privileges to add a name to be included in the contact list.

Timeline Report page 280 may also include Download buttons 300, allowing user 110 to create a report in a variety of electronic formats. For example, Timeline Reports page 280 may include a Download PDF button 302, which allows user 110 to create a report in portable document format, and a Download MS Word button 304, which allows user 110 to create a report in Microsoft® Word format.

Reports generated from Timeline Reports page 280 may be either service timeline reports or stewardship reports. A service timeline report may include a service timeline agreement, outlining future services to be performed for a client. The service timeline agreement may consist of language in the service timeline report that outlines the responsibilities and expectations of both the client and the broker/agent. A stewardship report is a backward-looking report, outlining the promises that the broker/agent has made to the insureds, and showing whether the broker/agent has complied with those promises.

System 100 allows user 110 to produce customized service timeline reports. The service timeline reports include a listing of selected timelines associated with a given client, broken down by top-level service category. Under each top-level service category, the timeline will include headings for an Activity, an Agency/Broker Champion, and a Target Date. If user 110 has chosen to include a contact list by using contact list tool 292 on Timeline Reports page 280, a contact list will also be included.

System 100 may also allow authorized user 110 to filter the information presented in the service timeline or stewardship report by at least one of a client account, participant, target date range, completion date range, service category, service activity, and compliance status. System 100 may also include a compliance snapshot utility feature. The compliance snapshot utility may be integrated into the service timeline portion of interface 116. The compliance snapshot utility may show a compliance rating and a service rating for one or more of the service timelines for a given client. In one exemplary embodiment, the compliance rating is a percentage that is calculated by dividing the number of value-added services completed on time by the total number of value-added services in the service timeline whose due date has passed. The service rating may also be a percentage, calculated by dividing the tracking metric units used by the tracking metric units available. The compliance rating and service rating can be included as part of a stewardship report, thus allowing the broker/agent, manager, executive, and client to quickly view the level of service that is being provided.

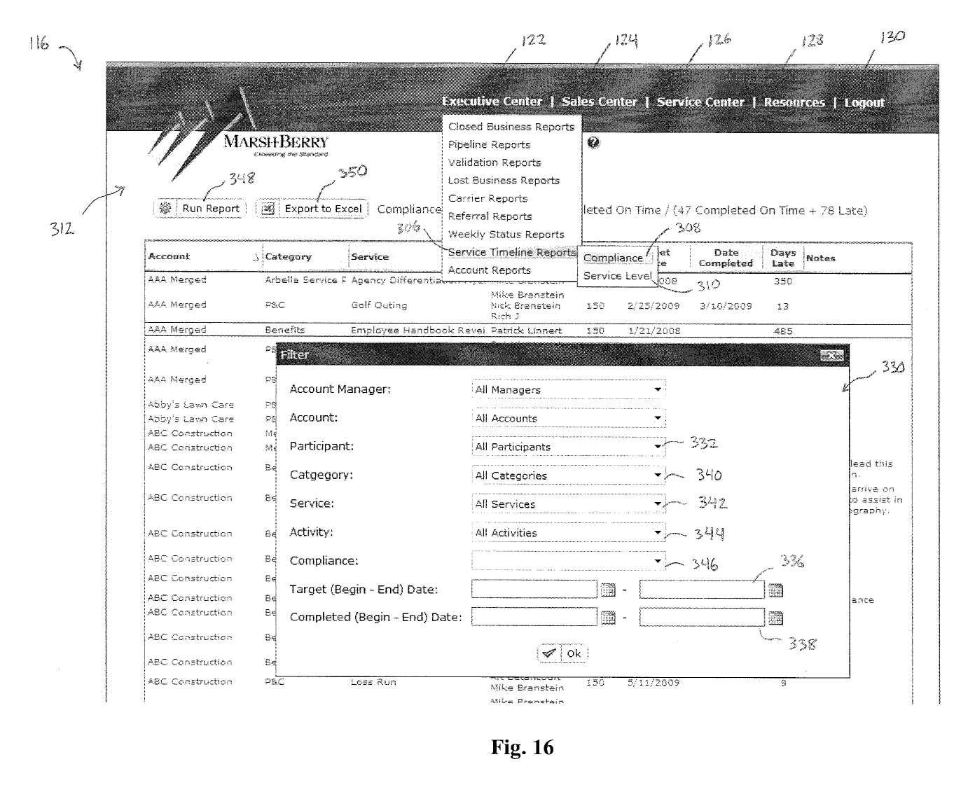

Advantageously, System 100 also allows an individual from an organization to view compliance and service information from across the entire organization. As shown in FIG. 16, executive user 114 is able to access an executive review portion of interface 116 by clicking on or otherwise selecting Executive Center link 122. Selecting Executive Center link 122 provides access to a menu that includes a Service Timeline Reports option 306. Selecting the Service Timeline Reports option 306 provides access to a submenu containing a Compliance option 308 and a Service Level option 310. Selecting Compliance option 308 provides access to a Compliance Report page 312.

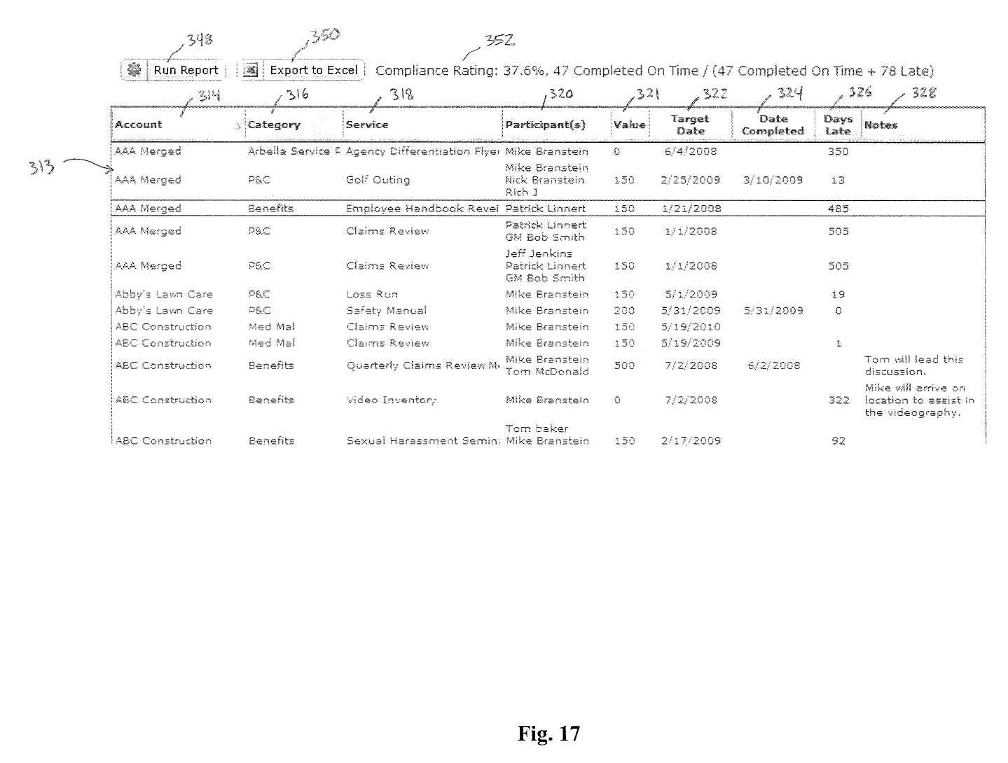

FIG. 16 illustrates Compliance Report page 312, which displays a table 313, details of which are shown in FIG. 17. Table 313 that includes an Account data field 314, a Category data field 316, a Service data field 318, a Participant data field 320, a Value field 321, a Target Date data field 322, a Date Completed data field 324, a Days Late data field 326, and a Notes data field 328. By default, Compliance Report page 312 displays all activities associated with a given organization. However, Compliance Report page 312 may also provide access to a Compliance Filter 330 that allows user 114 to change the activities shown in the compliance report table. Compliance Filter 330 allows executive user 114 to customize Compliance Report page 312 to show a wide variety of information about the services that have been or will be provided to clients.

Compliance Filter 330 includes a Participant tool 332, a Service Timeline tool 334, a Target Date Range tool 336, a Completion Date Range tool 338, a Category tool 340, a Service tool 342, an Activity tool 344, and a Compliance tool 346.

Participant tool 332 allows executive user 114 to select from a list of participants that have been entered into system 100 by administrator 112. Participant tool 332 will allow user 114 to select all participants present in the system for a given organization, specific groups of participants, or individual participants.

Service Timeline tool 334 allows user 114 to select an existing service timeline setup by administrator 112 on Service Timeline Setup Page 136. This allows user 114 to view services that are being provided to a specific client.

Target Date Range tool 336 and Completion Date Range tool 338 allow user 114 to view only those services that fall within a specific range of dates, either for the target date, i.e. the date that the participant promised the service to the client, or for the actually date that the service was completed. User 114 will be able to show all services that have been performed for a given client, the year-to-date services provided to a client, and any other desired date range.

The Category tool 340 and Service tool 342 allow user 114 to choose from the top-level service categories previously defined by administrator 112 on Category Mappings page 170. Once user 114 has selected a top-level service category, Service tool 342 will allow user 114 to select a service that has been mapped to the top-level service domain. User 114 will be able to select all services mapped to the service category, or a specific service.

The Activity tool 344 allows user 114 to choose whether Compliance Report Page 312 displays all activities, only completed activities, or only incomplete activities. Compliance tool 346 allows user 114 to choose whether Compliance Report page 312 displays all activities, only on-time activities, or only late activities.

In one exemplary embodiment, Compliance Report page 312 automatically refreshes based on the selections made by user 114. In another exemplary embodiment, Compliance Report page 312 includes a Run Report button 348. Selecting the Run Report button 348 will change Compliance Report page 312 to reflect the selections made by user 114. Compliance Report page 312 may also include an Export button 350, which allows a user to export the data displayed on Compliance Report page 312 to an external file, such as a spreadsheet file, a text file, or any other suitable file format.

Compliance Report page 312 also includes a Compliance Rating field 352, as shown in FIG. 17. Compliance Rating field 352 is a dynamic data field that automatically updates when new criteria is entered into Compliance Filter 330. Compliance Rating field 352 displays a compliance rating based on the criteria entered into Compliance Filter 330. In one exemplary embodiment, the compliance rating is calculated by dividing the number of service activities completed on time shown on Compliance Report page 312 by the number of service activities with a deadline that has passed shown on Compliance Report page 312. In other words, compliance rating=(service activities completed on time)/(service activities completed on time+service activities completed late). For example, Compliance Rating field 352 indicates that for the selected filter, there are 125 total activities, 47 of which were completed on time, and 78 of which were completed late. The compliance rating score is thus calculated to be (47/(47+78))=37.6%.

Compliance Rating field 352 may also display the total number of service activities shown, the number of activities completed on time, the number of activities that are currently pending, and the number of activities that were completed late.

Compliance Report page 312 allows an executive user 114 to efficiently view compliance auditing information as it relates to accounts, categories, services, individuals, and many other categories. This allows executive user 114 to quickly access a wealth of information that will allow the user to see which areas need to be improved.

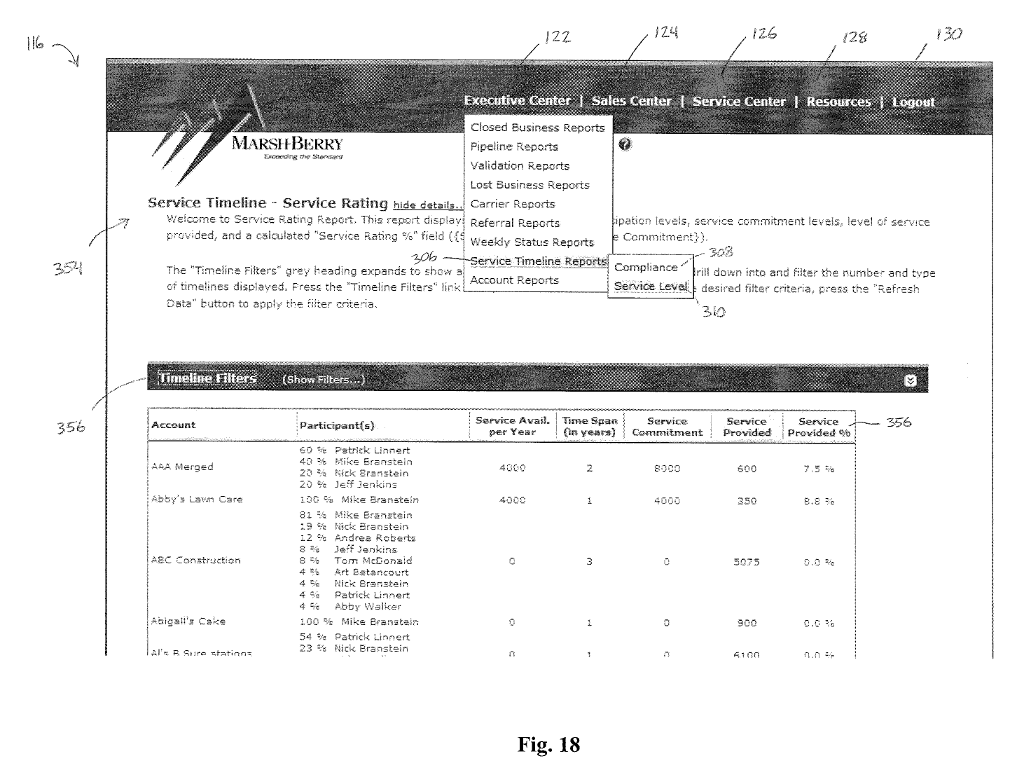

FIG. 18 illustrates a Service Rating page 354 of system 100. Service Rating page 354 is accessed by selecting Service Level link 310 from within the Service Timeline Reports submenu. Service Rating page 354 provides functionality for tracking and displaying service ratings. In one exemplary embodiment, only an executive user 114 is able to access a Service Rating page.

Service Rating page 354 displays timelines, employee participation levels, service commitment levels, level of service provided, and a calculated Service Rating field 356. Service Rating page 354 includes a table with data fields including the Account, Participants, Service Available per year, Time Span (in years), Service Commitment, Service Provided, and Service Rating. The service rating is a calculation of the service provided as a percentage of the total service available within a metric band. The service rating is calculated by dividing the Service Provided by the Service Commitment. The Service Provided category may be derived from the metric band determination made by administrator 112 in the agency set-up portion of system 100. For example, if the Service Commitment to a given client within a given metric band is 10000 units (measured in dollars, hours, or another metric), and the client has been provided with 575 units to date, the service rating is calculated to be 575/10000=5.75%.

Service Rating page 354 includes a Timeline Filter 356 that has similar functionality to the Compliance Filter 330 shown in FIG. 16. Timeline Filter 356 allows user 114 to limit the number of service timelines shown on the page. User 114 is able to customize the timeline shown by selecting the participants, the timelines, the categories, the services, and the dates to be shown. Service Rating page 354 may also include a Refresh Data button and an Export button, with similar functionality to the buttons explained above in reference to the Compliance Report page 312.

The methods and systems of the present invention, as described above and shown in the drawings, provide for an integrated, robust technology platform for creating, tracking, managing, and auditing service timelines that can be used by professional service agencies of any size to better implement value-added service programs. It will be apparent to those skilled in the art that various modifications and variations can be made to the systems and methods of the present invention without departing from the scope of the invention as outlined in the appended claims and their equivalents.

The invention claimed is:

1. A system for tracking and managing value-added services and service timelines provided to a client by an agency, the system comprising:
a database housing service information for the agency;
a service management server interfacing with the database;
a display device connected to the service management server;
a user interface module running on the service management server, the user interface module being configured to receive input from a suer and to display content from the database on the display device;
an agency set-up portion of the user interface allowing an authorized administrator to associate the client account data with an agency account; and
a service timeline portion of the user interface allowing an authorized user to view and edit an interactive client account service timeline generated from the client account data, wherein the interactive client account service timeline includes a plurality of editable data fields, including editable data fields for a value-added service category, a description of a value-added service, a tracking metric, a list of one or more participants, a target date for completion of the service, and an actual completion date for the service.

2. The system of claim 1, wherein the agency set-up portion includes a service category set-up section allowing the authorized administrator to add, modify, or delete a value-added service category, wherein the authorized user can only select from the value-added service categories entered into the system by the authorized administrator.

3. The system of claim 3, wherein the agency set-up portion includes a value-added service set-up section allowing the authorized administrator to add, modify, or delete a value-added service description, wherein the authorized user can only select from the value added service descriptions entered into the system by the authorized administrator.

4. The system of claim 4, wherein the agency set up portion further includes a category mapping section allowing the authorized administrator to map the value added service description to a value-added service category.

5. The system of claim 5, wherein the agency set-up section further includes a utility for assigning a tracking metric to each mapped service.

6. The system of claims 5, wherein the agency set-up section further includes a utility for defining metric bands to limit the quantity of value added services offered to the client based an amount of commission generated for the agency by the client.

7. The system of claim 5, wherein the tracking metric is selected from the group consisting of dollars, hours, and points.

8. The system of claim 1, wherein the service timeline portion of the user interface includes a plurality of service timelines for a single client account, the service timelines being grouped according to a predetermined value-added service category.

9. The system of claim 1, wherein the service timeline portion of the user interface includes a timeline filter allowing the authorized user to change and sort the information presented in the service timeline.

10. The system of claim 9, wherein the timeline filter allows the authorized user to filter the information presented by at least one of a client account, participant, target date range, completion date range, service category, service activity, and compliance status.

11. The system of claim 1, wherein the service timeline portion of the user interface includes a compliance snapshot utility that shows a compliance rating and a service rating for at least one of the service timelines.

12. The system of claim 11, wherein the compliance rating is a percentage calculated by dividing the number of value-added services completed on time by the total number of value-added services past due in the service timeline.

13. The system of claim 11, wherein the service rating is a percentage calculated by dividing the tracking metric units used by the tracking metric units available.

14. The system of claim 1, wherein the service timeline portion further comprises a report generating section allowing the authorized user to automatically generate a customized report based on at least one of the service timelines.

15. The system of claim 11, wherein the customized report includes a service timeline agreement.

16. The system of claim 11, wherein the customized report includes a stewardship report that includes the service timeline, the compliance rating, and the service rating.

17. The system of claim 1, further comprising an executive review portion of the web-based user interface allowing an authorized executive to view compliance ratings and service ratings for the entire agency account.

18. The system of claim 17, wherein the executive review portion allows the authorized executive to view the compliance and service ratings by individual.

19. The system of claim 18, wherein the executive review portion allows the authorized executive to view the compliance and service ratings by client account.

20. A method for tracking and managing value-added services provided to a client by an agency, the method comprising:
creating a client account within a secure web-based interface;
populating a database with data regarding the client account using the web-based interface;
automatically generating an interactive service timeline for the client account using the data stored in the database, wherein the service timeline includes data fields for a service activity, the service activity being associated with at least one of a target completion date, a participant, a tracking metric, and an actual completion date;
outputting the interactive service time line to the web-based interface; and
allowing an authorized user to view and modify the interactive service timeline.

21. The method of claim 20, wherein the step of populating the database with data regarding the client account includes populating the database with data regarding service promises made to the client.

22. The method of claim 21, wherein the step of populating the database with data regarding the client account includes populating the database with data regarding service actions taken with regard to the service promises made to the client.

23. The method of claim 20, further comprising automatically generating a report based on the interactive service timeline.

24. The method of claim 23, wherein the report includes a service timeline agreement.

25. The method of claim 23, wherein the report includes a compliance score.
